(19) United States
(12) Patent Application Publication
(10) Pub. No.: US 2025/0162330 A1
(43) Pub. Date: May 22, 2025

(54) RECORDING DEVICE AND RECORDING METHOD

(71) Applicant: SEIKO EPSON CORPORATION, Tokyo (JP)

(72) Inventors: Michiru ABE, SHIOJIRI-SHI (JP); Tsuneyuki SASAKI, MATSUMOTO-SHI (JP)

(21) Appl. No.: 18/950,316

(22) Filed: Nov. 18, 2024

(30) Foreign Application Priority Data
Nov. 22, 2023 (JP) 2023-198052

(51) Int. Cl. B41J 11/00; B41J 3/407; D06P 5/30

(52) U.S. Cl. CPC B41J 11/002; B41J 3/4078; D06P 5/30

(57) ABSTRACT

A recording device 1 includes a recording section 7 configured to record an image 2 on a medium 3 transported in a transport direction F based on image data 5 and a control section 9. The recording section 7 includes an ink head 71 configured to eject pigment ink 11 onto a fabric material 31 of the medium 3 and a curing process head 72 configured to eject curing process liquid 13 that cures the fabric material 31 in a state in which the fabric material 31 is permeated. The control section 9 executes a first control 91 for recording the image 2 onto the medium 3 by ejecting the pigment ink by the ink head 71 and a second control 92 for ejecting the curing process liquid 13 onto the curing target area 15 of the medium 3 by the curing process head.

The present application is based on, and claims priority from JP Application Serial Number 2023-198052, filed Nov. 22, 2023, the disclosure of which is hereby incorporated by reference herein in its entirety.

### BACKGROUND

### 1. Technical Field

The present disclosure relates to a recording device and a recording method.

### 2. Related Art

An example of this type of device is a printing device described in JP-A-2012-86461.

JP-A-2012-86461 discloses ejecting a second ink onto a recording medium based on cut information, cutting the portion on which the second ink was ejected as a cut position, and that the second ink is a colorless transparent ultraviolet curable ink.

In the printing device of JP-A-2012-86461, ultraviolet curable ink is ejected to the cut position. This ultraviolet curable ink adheres to the surface of the recording medium and has almost no permeability between the fibers inside the medium. Therefore, problems hardly arise when the recording medium is paper or the like, but when the recording medium is a thin fabric or a soft fabric, since ultraviolet curable ink adheres only to the surface of the fabric, cutting strength is insufficient and cutting becomes difficult or impossible in some cases when the cutting position is cut by a cutter or the like. There is a case where fraying occurs from a cut surface and fluff is generated. The fraying causes the fabric material of the medium to degrade. The fluff causes the recording head to deteriorate the performance.

When fabric material as a medium is transported for printing, a localized pulling force may be applied to cause distortion, wrinkles, or the like in the fabric material. When sewing with a sewing machine or the like, the thin fabric or the soft fabric may twist when the fabric material is fed, or the sewing machine needle may push the fabric material rather than penetrate it, causing sewing defects. However, there is no description to consider these problems in JP-A-2012-86461.

### SUMMARY

In order to solve the above problem, a recording device includes a recording section configured to record an image on a medium transported in a transport direction based on image data and a control section, wherein the recording section includes an ink head configured to eject pigment ink onto a fabric material of the medium and a curing process head configured to eject curing process liquid that cures the fabric material in a state where the fabric material is permeated and the control section executes a first control for using the ink head to record the image onto the medium by ejecting pigment ink and a second control for using the curing process head to eject the curing process liquid onto a curing target area of the medium.

The recording method for the recording device according to the present disclosure, the recording device including a recording section configured to record an image on a medium transported in a transport direction based on image data and a control section, wherein the recording section includes an ink head configured to eject pigment ink onto a fabric material of the medium and a curing process head configured to eject curing process liquid that cures the fabric material in a state where the fabric material is permeated and in the recording method, the control section executes the following (1) and (2).

(1) executing a first control for recording an image onto the medium by ejecting pigment ink by the ink head.

(2) executing a second control for ejecting the curing process liquid onto a curing target area of the medium by the curing process head.

### BRIEF DESCRIPTION OF THE DRAWINGS

FIG. 1 is an overall schematic configuration diagram of a recording device according to a first embodiment.

FIG. 2 is a plan view of a medium showing an execution result of a second control according to the first embodiment.

FIG. 3 is a plan view of the medium showing the execution result of the second control according to the first embodiment.

FIG. 4 is a plan view of the medium showing the execution result of the second control in a different image of the first embodiment.

FIG. 5 is a plan view of the medium showing the execution result of the second control according to a second embodiment.

FIG. 6 is a plan view of the medium showing the execution result of the second control according to the second embodiment.

FIG. 7 is a plan view of the medium showing the execution result of the second control according to the second embodiment.

FIG. 8 is a plan view of the medium showing the execution result of the second control according to a third embodiment.

FIG. 9 is a plan view of the medium showing the execution result of the second control according to the third embodiment.

FIG. 10 is a plan view of the medium showing the execution result of the second control according to a fourth embodiment.

FIG. 11 is a plan view of the medium showing the execution result of the second control according to the fourth embodiment.

### DESCRIPTION OF EMBODIMENTS

The present disclosure will first be schematically described below.

A recording device according to a first aspect of the present disclosure includes a recording section configured to record an image on a medium transported in a transport direction based on image data and a control section, wherein the recording section includes an ink head configured to eject pigment ink onto a fabric material of the medium and a curing process head configured to eject curing process liquid that cures the fabric material in a state where the fabric material is permeated and the control section executes a first control for using the ink head to record the image onto the medium by ejecting pigment ink and a second control for using the curing process head to eject the curing process liquid onto a curing target area of the medium.

According to the present aspect, the curing process liquid ejected from the curing process head permeates throughout the fabric material of the medium and cures the fabric material in the permeated state. That is, the curing process liquid cures not only on the surface of the medium but also in a state where it permeates between fibers inside the medium. Therefore, even when the medium is a thin fabric, a soft fabric, or the like, by ejecting the curing process liquid onto the curing target area, which is a portion desired to be cured, the curing target area is brought into a state of being cured from the surface to the permeated inside of the medium.

By this, when the portion cured with the curing process liquid is performed processing process by, for example, cutting with a cutter or sewing with a sewing machine, the curing effect, that is, the curing extending from the surface to the inside, suppresses the occurrence of wrinkles, distortions, fraying, or the like in the fabric, making it easier to perform a processing process such as cutting or sewing.

A second aspect of the recording device according to the present disclosure is an aspect according to the first aspect, wherein the second control sets, as the curing target area, a first region that surrounds the image formed with pigment ink.

According to the present aspect, the second control sets the first region, which surrounds the image formed with pigment ink, as the curing target area. By this, when cutting the first region surrounding the image, the cutting can be easily performed due to the effect of the curing.

A third aspect of the recording device according to the present disclosure is an aspect according to the second aspect, wherein the first region is a region surrounding the image, along a contour of the image formed with pigment ink.

According to the present aspect, the first region is a region surrounded along the contour of the image formed with pigment ink. By this, when cutting along the contour of the image, the cutting can be easily performed due to the effect of the curing. Since the region surrounded along the contour of the image is cured, the strength of the image portion surrounded by the first region is increased and the handling thereof is facilitated.

A fourth aspect of the recording device according to the present disclosure is an aspect according to the first aspect or the second aspect, wherein the second control sets, also as the curing target area, a second region that is positioned upstream and downstream in the transport direction of the image formed with pigment ink onto the medium and that extends over the entire length of the width of the medium.

According to the present aspect, the second region where the curing process liquid is ejected and cured is positioned upstream and downstream in the transport direction of the image and is extended over the entire length of the width of the medium. By this, even when a localized pulling force is applied when the fabric, which is the medium, is transported for printing, since the second region over the entire length of the width of the medium is cured, it is possible to suppress the occurrence of distortion or wrinkles in the fabric material of the medium.

A fifth aspect of the recording device according to the present disclosure is an aspect according to the fourth aspect, wherein the second control sets, also as the curing target area, a third region that connects both end positions in the width direction of the second region.

According to the present aspect, the second control sets the third region also as the curing target area in addition to the second region. That is, the second region and the third region form a rectangle shape and in a state of surround the image and the first region. By this, even when a localized pulling force is applied when the fabric, which is the medium, is transported for printing, since the second region and the third region are cured in the rectangle shape, it is possible to further suppress the occurrence of distortion or the like in the fabric material of the medium.

Since the rectangle shape is formed in a state where the third region is positioned on each side of the medium, the entire portion forming the rectangle shape of the medium is unlikely to be distorted even when a localized pulling force is applied. For example, even when there is, for example, only one image inside the rectangle shape, the distortion or the like is less likely to occur.

A sixth aspect of the recording device according to the present disclosure is an aspect according to the second aspect, wherein the first control records a plurality of images positioned separate from each other on the medium and the second control sets, also as the curing target area, a fourth region that surrounds the plurality of images, the fourth region being positioned on an inner side separated from both sides along the transport direction of the medium.

According to the present aspect, since the fourth region is provided at a position close to the image and the first region, even when a localized pulling force is applied to the medium, the medium is further less likely to be distorted.

A seventh aspect of the recording device according to the present disclosure is an aspect according to the sixth aspect, wherein the second control sets, also as the curing target area, the second region that is positioned upstream and downstream of the fourth region in the transport direction and that extends over the entire length of the width of the medium and sets, also as the curing target area, the third region that connects both end positions in the width direction of the second region.

According to the present aspect, since the image and the first region are surrounded by the fourth region and the rectangle shape formed by the second region and the third region is provided around the fourth region, even when a localized pulling force is applied to the medium, the medium is further less likely to be distorted.

An eighth aspect of the recording device according to the present disclosure is according to the first aspect or the second aspect, wherein the second control sets a sewing area corresponding to a sewing line as the curing target area.

Note that the present aspect may be according to any one of the third aspect to the seventh aspect.

According to the present aspect, the second control sets the sewing area, which corresponds to the sewing line, as the curing target area. That is, the sewing line to be performed sewing by the sewing machine or the like ha cured the curing process using the curing process liquid. By this, when a thin fabric or a soft fabric is sewn by a sewing machine or the like, it is possible to reduce the possibility that the fabric material becomes twisted when the fabric material is fed or that the sewing machine needle pushes the fabric material without penetrating it, causing sewing defects.

A recording method of a recording device according to the ninth aspect of the present disclosure, the recording device including a recording section configured to record an image on a medium transported in a transport direction based on image data and a control section, wherein the recording section includes an ink head configured to eject pigment ink onto a fabric material of the medium and a curing process head configured to eject curing process liquid that cures the fabric material by permeation into the fabric material and in the recording method, the control section executes the following (1) and (2).

(1) executing a first control for recording an image onto the medium by ejecting pigment ink by the ink head.

(2) executing a second control for ejecting the curing process liquid onto a curing target area of the medium by the curing process head.

According to the present aspect, the same effects as those of the first aspect are obtained as the recording method.

### Embodiments

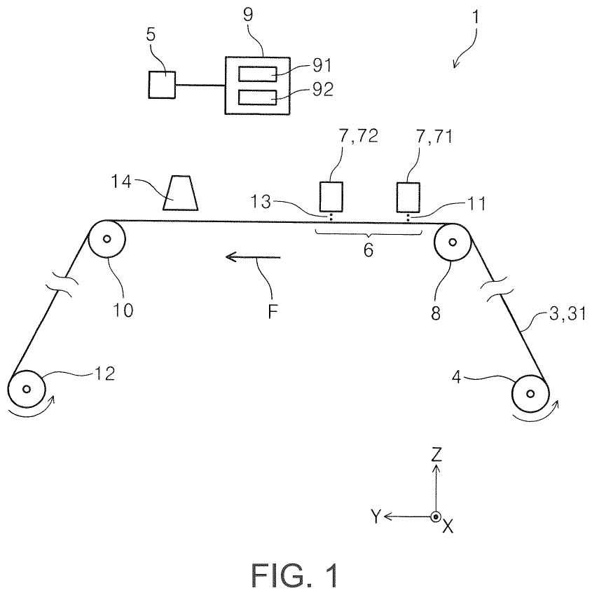

Hereinafter, an embodiment of a recording device according to the present disclosure will be specifically described based on FIG. 1 to FIG. 11.

In the following description, three axes orthogonal to each other are referred to as an X-axis, a Y-axis, and a Z-axis, respectively, as shown in each drawing. The direction indicated by the arrows of the three axes (X, Y, and Z) is the +direction of each direction, and the opposite direction is the −direction. The Z-axis direction corresponds to a vertical direction, that is, a direction in which gravity acts, a +Z direction indicates a vertically upward direction, and a −Z direction indicates a vertically downward direction. The X-axis direction and the Y-axis direction correspond to horizontal directions. The +Y direction indicates the direction to the front of the device and the −Y direction indicates the direction to the rear of the device. The +X direction indicates the direction to the right of the device and the −X direction indicates the direction to the left of the device.

### First Embodiment

A recording device 1 of the present embodiment is an inkjet printer.

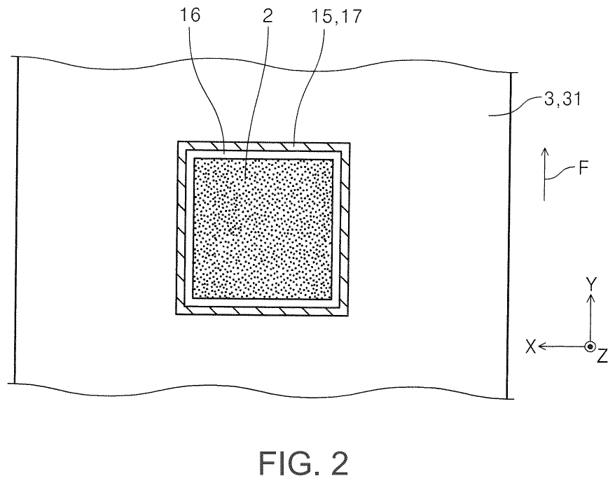

As shown in FIG. 1 and FIG. 2, the recording device 1 includes a recording section 7, which records an image 2 (FIG. 2) based on image data 5 on a medium 3, which is transported in a transport direction F, and a control section 9. The recording section 7 includes an ink head 71 that ejects pigment ink 11 onto a fabric material 31 of the medium 3 and a curing process head 72 that ejects curing process liquid 13 that cures the fabric material 31 in a state where the fabric material 31 is permeated.

The control section 9 is configured to execute a first control 91 for recording the image 2 onto the medium 3 by ejecting pigment ink by the ink head 71 and a second control 92 for ejecting the curing process liquid 13 onto a curing target area 15 of the medium 3 by the curing process head.

In the present embodiment, the ink head 71 and the curing process head 72 have a nozzle array (not shown) and they are both serial type heads that are reciprocated by a carriage (not shown) in the width direction of the medium 3, which is a direction intersecting the transport direction F, that is, in the X-axis direction. The pigment ink 11 and the curing process liquid 13 are ejected from the nozzle array toward the medium 3.

FIG. 1 shows a structure in which the ink head 71 is disposed upstream of the curing process head 72 in the transport direction F, but the structure is not limited to this. Any structure may be used as long as the formation of the image 2 by the ink head 71 and the ejection of the curing process liquid by the curing process head 72 can be performed based on the image data 5. For example, the ink head 71 and the curing process head 72 may be mounted on a single carriage.

In the present embodiment, the recording device 1 is configured such that the medium 3 is sent out in the transport direction F by a feed roller 4, passes through a recording execution area 6 of the recording section 7 via transport rollers 8 and 10, and is winded up by a winding roller 12. In FIG. 1, reference symbol 14 denotes a heater. The heater 14 is positioned downstream of the recording section 7 and heats the medium 3 to a predetermined temperature. By this heating, the curing process liquid ejected onto the curing target area 15 of the medium 3 is cured. Note that, natural curing may be performed without providing the heater 14.

The control section 9 has control modes for executing the first control 91 for receiving the image data 5 and driving the ink head 71 and the second control 92 for driving the curing process head. Further, the control section 9 controls the transport driving of the medium 3 by the feed roller 4 and the winding roller 12. The medium 3 is intermittently transported by the feed roller 4 and the winding roller 12. While the medium 3 is in a stopped state, the pigment ink 11 and the curing process liquid 13 are ejected, based on the image data 5, on a predetermined position.

The control section 9 includes a CPU, a flash ROM, and a RAM. The CPU performs various arithmetic processing according to the program stored in the flash ROM and controls the operation of the recording device 1 as a whole. The flash ROM, which is an example of the storage unit, is a nonvolatile memory that can be read from or written into. Various kinds of information are temporarily stored in the RAM, which is an example of the storage unit.

### Medium

In the present embodiment, the medium 3 on which recording is performed by the recording section 7 is a thin fabric material 31, a soft fabric material 31, or the like and there is a concern that a problem or the like may occur, such as that cutting by a cutter after the image 2 is recorded is not easy or impossible in terms of strength Specific examples thereof include a fabric, which is a woven fabric made by crossing a warp and a weft, a knit, which is a knitted fabric made by forming a loop with a single thread and intertwining the loop with an adjacent loop, and a nonwoven fabric, which is made by intertwining or bonding fibers together. That is, the medium 3 made of the fabric material 31 in which the above described problems may occur is the target on which recording is performed by the recording section 7.

The medium 3, which is likely to be distorted or wrinkled when a localized pulling force is applied to the medium 3, is also similarly targeted from the viewpoint of making it difficult to cause distortion or wrinkle.

Even when the medium 3 is not to be cut, the medium 3 has a portion to be sewn by the sewing machine or the like and the medium 3 in which the portion easily causes a sewing defect in terms of strength is also considered as a target in the same manner from the viewpoint of reinforcement.

### Curing Process Liquid

The curing process liquid 13 ejected by the curing process head 72 may be any liquid as long as it permeates the fabric material 31 of the medium 3 such as fabric and cures the fabric material 31 in the permeated state. The permeability of the curing process liquid 13 is greater than that of the ultraviolet curable ink, but it may be greater than or equal to a degree wherein generation of wrinkles, distortion, fraying, and the like in the fabric are suppressed and the processing process is facilitated when the curing process liquid 13 is applied to the medium 3, such as fabric, cured, and the cured region is subjected to a processing process such as cutting. Here, the curing process liquid 13 is transparent, but is not limited to the transparent one.

In the present embodiment, the overcoat liquid described in Japanese Patent No. 6736908, which is filed and patented by the applicant of the present application, is used as the curing process liquid 13.

The overcoat liquid contains a water-dispersible resin, a water-soluble organic solvent having a plurality of hydroxyl groups in the molecular structure, a crosslinkable component, and water, wherein the water-dispersible resin contains a urethane resin, the crosslinkable component contains a blocked isocyanate compound, the water-soluble organic solvent contains glycerin, and it is applied by a spray method or an inkjet method. Table 1 of the same patent publication describes specific components and compositions of the overcoat liquids as embodiment 1 to embodiment 9.

The inventors of the present application have confirmed that this overcoat liquid can be used as the curing process liquid 13 of the present disclosure for the curing process of the medium 3 such as the fabric, the knit, and the nonwoven fabric.

As pigment ink ejected by the ink head 71, black pigment ink and color pigment inks such as red, blue, and yellow, which are commonly used in inkjet printers for recording the image onto the medium 3 such as fabric, can be used. It is not limited to a specific pigment ink.

### Cutting of Portion Subjected to Curing Process

For the cutting process of the portion subjected to the curing process by ejecting the curing process liquid 13 onto the curing target area 15, an ordinary cutter such as a transverse cutting automatic cutter or a laser cutter cutting machine can be used. In the case of cutting with an automatic cutter, if position information of the curing target area 15, that is, information of the cutting position, can be used from the image data 5, then it is used. When image data cannot be used, cutting can be performed by detecting the cutting position where the curing process was performed with the curing process liquid 13 by a sensor such as a camera. It is also possible to cut manually without using an automatic cutter.

As shown in FIG. 2, in the present embodiment, the second control 92 sets the first region 17 surrounding the image 2 formed by the pigment ink 11 as the curing target area 15 of the medium 3.

In the present embodiment, in order to simplify the description, the image 2 will be described assuming that the outer shape is a square having a simple shape. Here, the cutting line by the cutter or the like is a square having a shape along the contour of the image 2. Therefore, the first region 17 is also square. There is a gap 16 between the image 2 and the first region 17 and the image 2 and the first region 17 are separate from each other.

The cutting line may not follow the contour of the image 2. In this case, although not shown, the first region 17 has a shape different from that of a square, and the gap 16 is not uniform as shown in FIG. 2. The width of the first region 17 is set according to the purpose of the curing process such as for cutting or sewing.

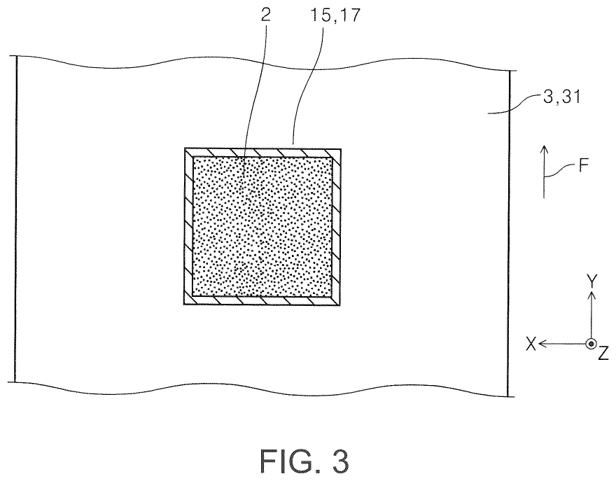

FIG. 3 is different from FIG. 2 only in that there is no gap 16. That is, the first region 17 is provided so as to be in contact with the periphery of the image 2.

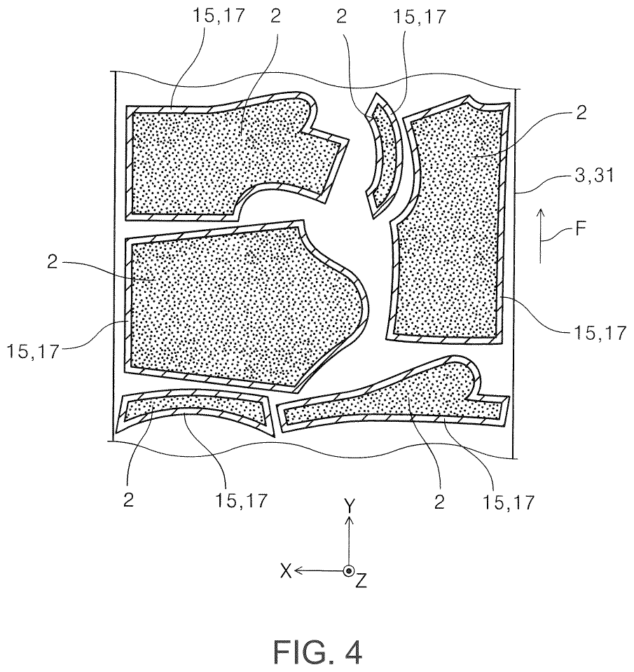

FIG. 4 shows a case where the image 2 is not a simple square. A plurality of images 2 are provided separate from each other. Each of the plurality of images 2, 2, and so on, has a different shape. Specifically, each of the plurality of images 2, 2, and so on, is a component for sewing and manufacturing an aloha shirt.

The first region 17 is provided in a state of being in contact with the periphery of the image 2 in the same manner as in FIG. 3. As shown in FIG. 4, when the plurality of images 2 surrounded by the first region 17 are provided in a state in which the images 2 are spread over the entire area of the medium 3 such as fabric in the width direction, the ratio of the first region 17, that is, the curing process region, is increased, so that the strength of the medium 3 is improved and the medium 3 can be easily handled.

### Description of Effects of First Embodiment

(1) In the present embodiment, the curing process liquid 13 ejected from the curing process head 72 permeates the fabric material 31 of the medium 3 and cures the fabric material 31 in the permeated state. That is, the curing process liquid 13 cures not only on the surface of the medium 3, but also in a state of permeation between the fibers inside the medium. Therefore, even when the medium 3 is a thin fabric, a soft fabric, or the like, by ejecting the curing process liquid 13 onto the curing target area 15, which is a portion desired to be cured, the curing target area 15 is brought into a state of being cured from the surface of the medium 3 to the permeated inside.

By this, when the portion cured by the curing process liquid 13 is processed, for example, by being cut with the cutter or the like, being sewn using the sewing machine, or the like, the occurrence of wrinkles, distortions, fraying, or the like in the fabric is suppressed due to the effect of the curing, that is, due to the curing extending from the surface to the inside, and the process such as cutting and sewing becomes easier.

(2) In the present embodiment, the second control 92 sets the first region 17 surrounding the image 2 formed by the pigment ink 11 as the curing target area 15. By this, when cutting the first region 17 surrounds the image 2, cutting can be easily performed due to the effect of the curing.

(3) In the present embodiment, the first region 17 is a region surrounding the image 2 along the contour of the image 2 formed with the pigment ink 11. By this, when cutting along the contour of image 2, cutting can be easily performed due to the effect of the curing. Since the region surrounding the image 2 along the contour of the image 2 is cured, the strength of the portion of the image 2 surrounded by the first region 17 is increased and the curing thereof is facilitated.

### Second Embodiment

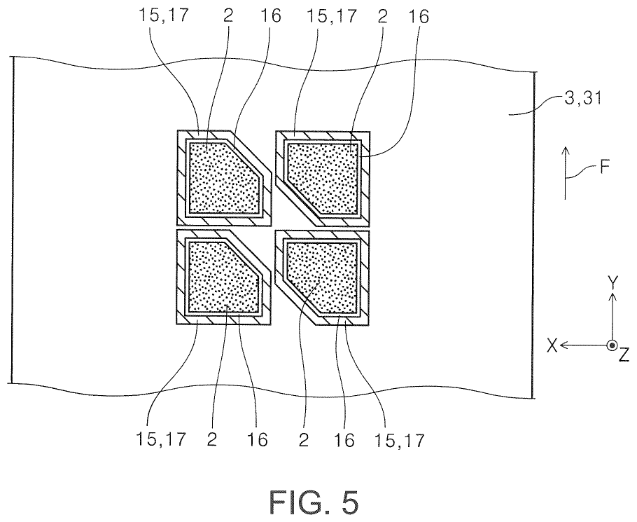

Next, the recording device 1 according to the second embodiment will be described based on FIG. 5 to FIG. 7. The same parts as those in the first embodiment are denoted by the same reference symbols and the description of the configuration and the corresponding effects thereof will be omitted.

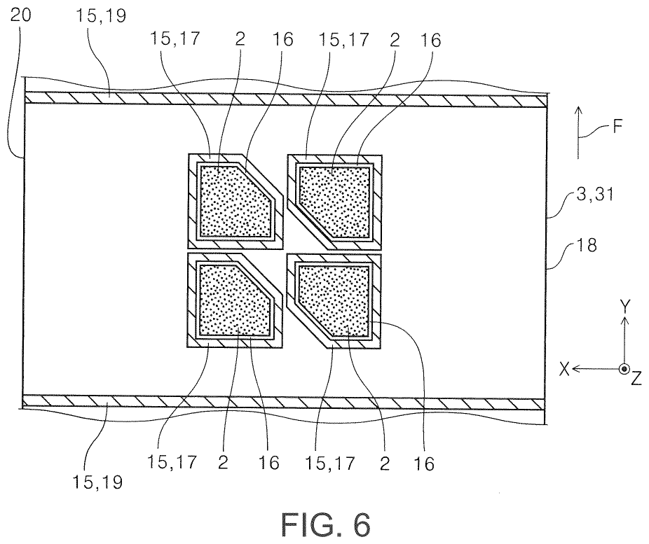

As shown in FIG. 6, in the present embodiment, the second control 92 is configured to set, also as the curing target area 15, a second region 19 that is positioned upstream and downstream in the transport direction F of the image 2 formed by the pigment ink 11 of the medium 3 and that extends over the entire length of the width of the medium 3. That is, both ends of the second region 19 reach each of sides 18 and 20 of the medium 3. The image 2 formed by the first control is a pentagon that is not a square here and four of them are provided substantially in the center of the medium 3 in the width direction.

FIG. 5 shows a state in which the second region 19 is not formed.

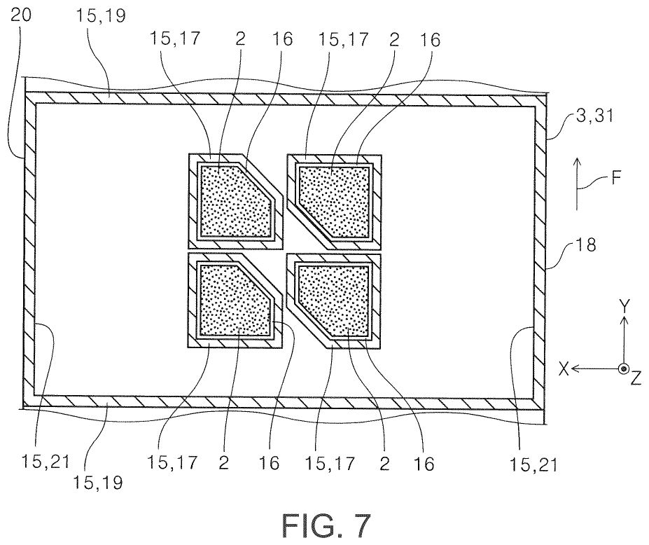

As shown in FIG. 7, further in the present embodiment, the second control 92 is configured to set, also as the curing target area 15, a third region 21 that connects both end positions of the second region 19 in the width direction of the medium 3. That is, the third region 21 is positioned at each of sides 18 and 20 of the medium 3.

In the present embodiment, the second region 19 and the third region 21 are provided in addition to the image 2 and the first region 17, but the second region 19, or the second region 19 and the third region 21, may be provided without providing the image 2 and the first region 17.

### Description of Effects of Second Embodiment

(1) In the present embodiment, the second region 19 where the curing process liquid 13 is ejected and cured is positioned upstream and downstream in the transport direction F of the image 2 and extends over the entire length of the width of the medium 3. By this, even when a localized pulling force is applied when the fabric, which is the medium 3, is transported for printing, since the second region 19 over the entire length of the width of the medium 3 is cured, it is possible to suppress the occurrence of distortion or wrinkles in the fabric material 31 of the medium 3.

(2) In the present embodiment, the second control 92 sets the third region 21 also as the curing target area 15 in addition to the second region 19. That is, the second region 19 and the third region 21 form a rectangle shape and in a state of surrounding the image 2 and the first region 17. By this, even when a localized pulling force is applied when the fabric, which is the medium 3, is transported for printing, since the second region 19 and the third region 21 are cured in the rectangle shape, it is possible to further suppress the occurrence of distortion or the like in the fabric material 31 of the medium 3.

Since the third region 21 forms the rectangle shape in a state of being positioned on each of the sides 18 and 20 of the medium 3, the entire portion forming the rectangle shape of the medium 3 is less likely to be distorted even when a localized pulling force is applied. For example, even when there is, for example, only one image 2 inside the rectangle shape, the distortion or the like is less likely to occur.

### Third Embodiment

Next, the recording device 1 according to the third

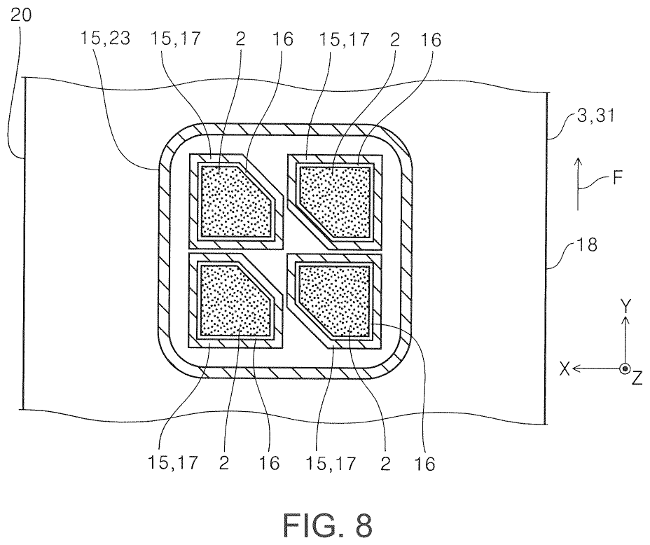

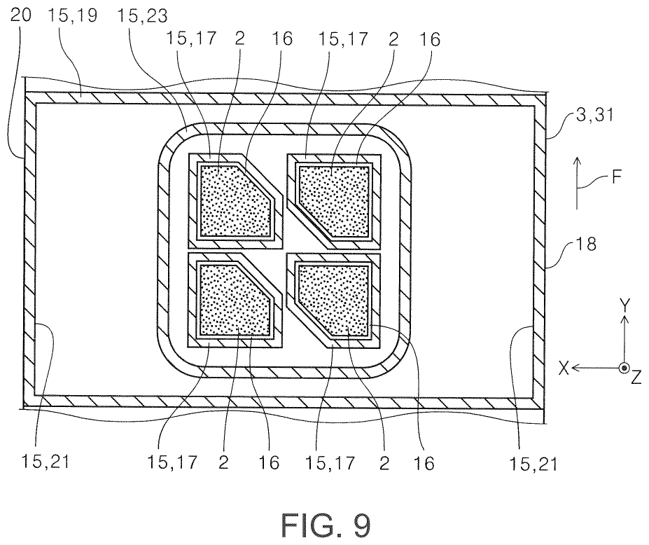

embodiment will be described based on FIG. 8 and FIG. 9. The same parts as those in the first embodiment and the second embodiment are denoted by the same reference symbols and the description of the configuration and the corresponding effects thereof will be omitted.

As shown in FIG. 8, in the present embodiment, the first control 91 is configured to record the four images 2 positioned separate from each other on the medium 3. The second control 92 is configured to set a fourth region 23, which surrounds the four images 2, also as the curing target area 15. The fourth region 23 is positioned on the inner side separated from both sides 18 and 20 that are along the transport direction F of the medium 3. That is, the fourth region 23 is provided at a position close to the four images 2, 2, and so on.

As shown in FIG. 9, further in the present embodiment, the second control 92 sets, also as the curing target area 15, the second region 19 that is positioned upstream and downstream of the fourth region 23 in the transport direction F and that extends over the entire length of the width of the medium 3. Additionally, it sets, also as the curing target area 15, the third region 21 that connects both end positions of the second region 19 in the width direction of the medium 3.

### Description of Effects of the Third Embodiment

(1) In the present embodiment, by providing the fourth region 23 at a position close to the image 2 and the first region 17, the medium 3 is further less likely to be distorted even when a localized pulling force is applied to the medium 3.

(2) In the present embodiment, since the image 2 and the first region 17 are surrounded by the fourth region 23 and a rectangle shape formed by the second region 19 and the third region 21 is provided around the fourth region 23, even when a localized pulling force is applied to the medium 3, it is further less likely to be distorted.

### Fourth Embodiment

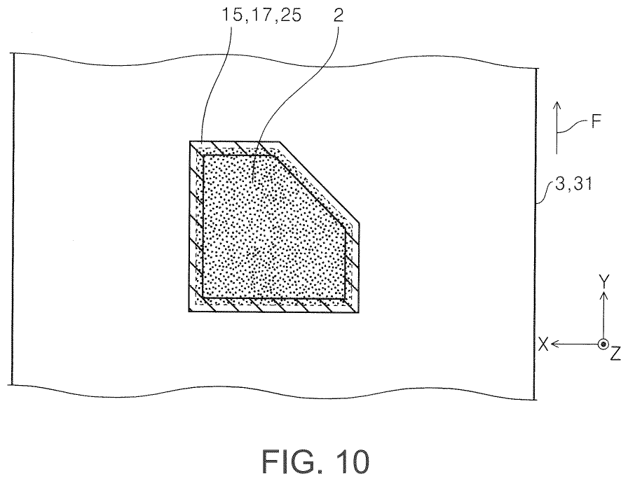

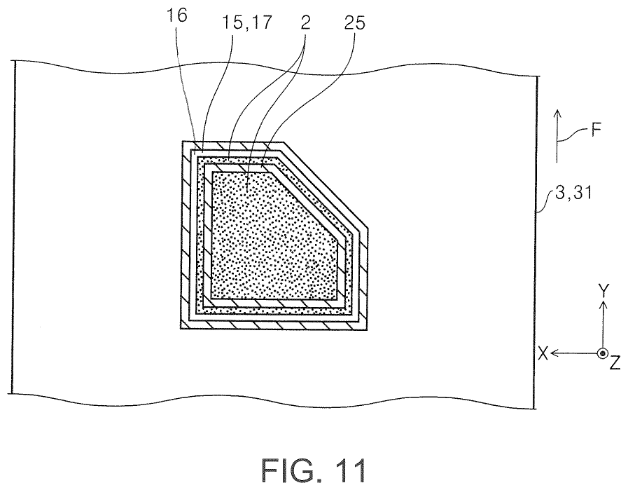

Next, the recording device 1 according to the fourth embodiment will be described based on FIG. 10 and FIG. 11. The same parts as those in the first embodiment, the second embodiment, and the third embodiment are denoted by the same reference symbols and the description of the configurations and the corresponding effects thereof will be omitted.

In the present embodiment, the second control 92 is configured to set a sewing area 25 corresponding to a sewing line to be sewn by a sewing machine or the like as the curing target area 15. The sewing area 25 is provided on the image 2 along the contour of the image 2.

FIG. 10 shows a case where the first region 17 and the sewing area 25 are integrally provided. That is, the first region 17 is positioned outside the contour position of the image 2. The sewing area 25 is positioned inside the contour position of the image 2. The first region 17 and the sewing area 25 are integrally provided in a continuous manner.

FIG. 11 shows a case where the sewing area 25 is provided independently of the first region 17. That is, the sewing area 25 is provided to the inside of the contour position of the image 2. The first region 17 is provided to the outside of the contour position of the image 2 via the gap 16.

In the present embodiment, the second control 92 sets the sewing area 25, which corresponds to the sewing line, as the curing target area 15. That is, the sewing line to be sewn by a sewing machine or the like is cured by the curing process using the curing process liquid 13. By this, when a thin fabric or a soft fabric is sewn by a sewing machine or the like, it is possible to reduce the possibility that the fabric material becomes twisted when the fabric material is fed or that the sewing machine needle pushes the fabric material without penetrating it, causing sewing defects.

### Other Embodiments

Although the recording device 1 according to the present disclosure basically has the configuration of the above described embodiment, it is of course possible to change or omit the partial configuration within the scope not departing from the gist of the present disclosure.

The above embodiment indicated the case where the sewing area 25 is positioned on the image 2, but it may be positioned to the outside of the contour of the image 2.

In the above embodiments, the first region 17, the second region 19, the third region 21, the fourth region 23, and the sewing area 25, which correspond to the curing target area 15, are formed by solid lines, but it is not limited to such a configuration. For example, the curing target area 15 may be constituted by a dashed line.

In the above embodiment, the second region 19 extends over the entire length of the width of the medium 3 and both ends thereof reach the sides 18 and 20 of the medium 3, but it is not limited to such a configuration. For example, the second region 19 may have at least a length component in the width direction of the medium 3 and both ends thereof may not reach the sides 18 and 20 of the medium 3.

What is claimed is:

1. A recording device comprising:
a recording section configured to record an image on a medium transported in a transport direction based on image data and
a control section, wherein
the recording section includes
an ink head configured to eject pigment ink onto a fabric material of the medium and
a curing process head configured to eject curing process liquid that cures the fabric material in a state where the fabric material is permeated and
the control section executes
a first control for using the ink head to record the image onto the medium by ejecting pigment ink and
a second control for using the curing process head to eject the curing process liquid onto a curing target area of the medium.

2. The recording device according to claim 1, wherein
the second control sets, as the curing target area, a first region that surrounds the image formed with pigment ink.

3. The recording device according to claim 2, wherein
the first region is a region surrounding the image, along a contour of the image formed with pigment ink.

4. The recording device according to claim 1, wherein
the second control sets, also as the curing target area, a second region that is positioned upstream and downstream in the transport direction of the image formed with pigment ink onto the medium and that extends over the entire length of the width of the medium.

5. The recording device according to claim 4, wherein
the second control sets, also as the curing target area, a third region that connects both end positions in the width direction of the second region.

6. The recording device according to claim 2, wherein
the first control records a plurality of images positioned separate from each other on the medium and
the second control sets, also as the curing target area, a fourth region that surrounds the plurality of images, the fourth region being positioned on an inner side separated from both sides along the transport direction of the medium.

7. The recording device according to claim 6, wherein
the second control sets, also as the curing target area, the second region that is positioned upstream and downstream of the fourth region in the transport direction and that extends over the entire length of the width of the medium and sets, also as the curing target area, the third region that connects both end positions in the width direction of the second region.

8. The recording device according to claim 1, wherein
the second control sets a sewing area corresponding to a sewing line as the curing target area.

9. A recording method for a recording device, the recording device including:
a recording section configured to record an image on a medium transported in a transport direction based on image data and a control section, wherein
the recording section includes
an ink head configured to eject pigment ink onto a fabric material of the medium and
a curing process head configured to eject curing process liquid that cures the fabric material by permeation into the fabric material and
in the recording method, the control section executes following (1) and (2)
(1) executing a first control for recording the image onto the medium by ejecting pigment ink by the ink head and
(2) executing a second control for ejecting the curing process liquid onto a curing target area of the medium by the curing process head.
